(19) United States
(12) Patent Application Publication
(10) Pub. No.: US 2022/0250784 A1
(43) Pub. Date: Aug. 11, 2022

(54) TRAY AND LOADING DEVICE FOR DISPLAY PRODUCT

(71) Applicants: Chongqing BOE Optoelectronics Technology Co., Ltd., Chongqing (CN); BOE TECHNOLOGY GROUP CO., LTD., Beijing (CN)

(72) Inventors: Yanli ZHAO, Beijing (CN); Xiaoji LI, Beijing (CN); Hailong WU, Beijing (CN); Gang CHEN, Beijing (CN); Pengbing XIE, Beijing (CN); Zhiqiang LIU, Beijing (CN); Jiaqin LI, Beijing (CN)

(21) Appl. No.: 17/486,028

(22) Filed: Sep. 27, 2021

(30) Foreign Application Priority Data
Feb. 9, 2021 (CN) 202120361293.1

(51) Int. Cl. B65D 1/36; G02F 1/1333; B65D 21/02; B65D 85/30; B65D 25/10

(52) U.S. Cl. CPC B65D 1/36; G02F 1/13338; B65D 25/10; B65D 85/30; B65D 21/0213

(57) ABSTRACT

An embodiment of the disclosure provides a tray, including at least one loading chamber, the loading chamber including: a first restriction recess and a second restriction recess located within an edge of a bottom face of the first restriction recess, wherein the first restriction recess is configured to load a touch cover and limit the touch cover, and the second restriction recess is configured to load a liquid crystal module and limit the liquid crystal module. The tray according to the embodiment of the disclosure can satisfy with the carrying requirements of the LCM and the TLCM, so that the carrying cost and the waste of resources can be effectively reduced. An embodiment of the disclosure also provides a loading device of a display product.

### CROSS-REFERENCE TO RELATED APPLICATIONS

This application claims priority from Chinese patent application No. 202120361293.1 entitled “TRAY AND LOADING DEVICE FOR DISPLAY PRODUCT” filed on Feb. 9, 2021 with the China National Intellectual Property Administration, the disclosure of which is incorporated herein by reference.

### FIELD OF THE INVENTION

Embodiments of the present disclosure relate to, but are not limited to, the field of display, and in particular, to a tray and loading device for display product.

### BACKGROUND

With the trends of thin and touch-integrated display products, the Touch cover is increasingly applied to the Liquid Crystal Display Module (also called Liquid Crystal Module). The structure formed by the Touch cover and the Liquid Crystal Module is generally abbreviated as TLCM (Touch Liquid Crystal Module). Due to the increasing degree of specialization of each factory, LCM production and TLCM production need to be performed in different factories. Therefore, after the LCM production is completed in an LCM manufacturing plant, a set of trays for carrying the LCM is required to transport the LCMs to a TLCM manufacturing plant. After the touch cover attaching process is completed in the TLCM manufacturing plant, a set of trays for carrying the TLCM is required to transport the TLCM to a next plant.

In the related art, the tray for loading the LCM and the tray for loading the TLCM are two different sets of trays, which results in an increase in transportation cost and a waste of resources.

### SUMMARY

The present disclosure is intended to solve at least one of the problems in the prior art and provides a tray and a loading device of display product.

In a first aspect, an embodiment of the present disclosure provides a tray, including at least one loading chamber, the loading chamber including: a first restriction recess and a second restriction recess located within an edge of a bottom face of the first restriction recess, wherein the first restriction recess is configured to load a touch cover and limit the touch cover, and the second restriction recess is configured to load a liquid crystal module and limit the liquid crystal module.

In some embodiments, the loading chamber further includes a third restriction recess, arranged on the same side of the first restriction recess and the second restriction recess and communicated with the first restriction recess and the second restriction recess, wherein the third restriction recess is configured to load and limit a printed circuit board connected to the liquid crystal module.

In some embodiments, the first restriction recess has a rectangular cross-sectional shape parallel to a bottom surface of the first restriction recess, and the touch cover to be loaded in the first restriction recess has a rectangular shape; and the second restriction recess has a rectangular cross-sectional shape parallel to a bottom surface of the second restriction recess, and the liquid crystal module to be loaded in the second restriction recess has a rectangular shape.

In some embodiments, at least one corner of the first restriction recess is formed as a convex rounded corner; and/or at least one corner of the second restriction recess is formed as a convex rounded corner.

In some embodiments, the rounded corner has a radius more than or equal to 4 mm

In some embodiments, a difference between a length of the first restriction recess and a length of the touch cover to be loaded in the first restriction recess is ranged from 0.5 mm to 0.7 mm; and a difference between a width of the first restriction recess and a width of the touch cover to be loaded in the first restriction recess is ranged from 0.5 mm to 0.7 mm.

In some embodiments, a difference between a length of the second restriction recess and a length of the liquid crystal module to be loaded in the second restriction recess is ranged from 0.5 mm to 0.7 mm; and a difference between a width of the second restriction recess and a width of the liquid crystal module to be loaded in the second restriction recess is ranged from 0.5 mm to 0.7 mm.

In some embodiments, a difference between a thickness of the liquid crystal module to be loaded in the second restriction recess and a depth of the second restriction recess is ranged from 0.1 mm to 0.3 mm

In some embodiments, the first restriction recess has a depth of 1.4 mm to 1.7 mm.

In some embodiments, the second restriction recess has a depth of 2.3 mm to 3.0 mm.

In some embodiments, the bottom surface of the second restriction recess is provided with a wavy reinforcing rib.

In some embodiments, a plurality of grooves for picking-up are arranged around the loading chamber, the grooves for picking-up are arranged at intervals along an edge of the loading chamber and are communicated with the loading chamber, and a distance from a bottom surface of each groove for picking-up to the top surface of the tray is greater than the distance from the bottom surface of the second recess to the top surface of the tray.

In some embodiments, two loading chambers are provided and are arranged along a width direction of the loading chambers.

In some embodiments, a material of the tray includes plastic; and the tray is integrally formed by injection molding.

In a second aspect, an embodiment of the present disclosure also provides a loading device of a display product, including: at least one tray according to according to the first aspect; and a resilient gasket, arranged in the first restriction recess of the tray.

In some embodiments, the loading chamber further includes a third restriction recess, arranged on the same side of the first restriction recess and the second restriction recess and communicated with the first restriction recess and the second restriction recess, wherein the third restriction recess is configured to load and limit a printed circuit board connected to the liquid crystal module.

In some embodiments, the first restriction recess has a rectangular cross-sectional shape parallel to a bottom surface of the first restriction recess, and the touch cover to be loaded in the first restriction recess has a rectangular shape; and the second restriction recess has a rectangular cross-sectional shape parallel to a bottom surface of the second restriction recess, and the liquid crystal module to be loaded in the first restriction recess has a rectangular shape.

In some embodiments, at least one corner of the first restriction recess is formed as a convex rounded corner; and/or at least one corner of the second restriction recess is formed as a convex rounded corner; and the rounded corner has a radius more than or equal to 4 mm

In some embodiments, a difference between a length of the first restriction recess and a length of the touch cover to be loaded in the first restriction recess is ranged from 0.5 mm to 0.7 mm; a difference between a width of the first restriction recess and a width of the touch cover to be loaded in the first restriction recess is ranged from 0.5 mm to 0.7 mm; a difference between a length of the second restriction recess and a length of the liquid crystal module to be loaded in the second restriction recess is ranged from 0.5 mm to 0.7 mm; and a difference between a width of the second restriction recess and a width of the liquid crystal module to be loaded in the second restriction recess is ranged from 0.5 mm to 0.7 mm

In some embodiments, a plurality of grooves for picking-up are arranged around the loading chamber, the grooves for picking-up are arranged at intervals along an edge of the loading chamber and are communicated with the loading chamber, and a distance from a bottom surface of each groove for picking-up to the top surface of the tray is greater than the distance from the bottom surface of the second recess to the top surface of the tray.

The tray and the loading device of display product according to the embodiments of the disclosure can satisfy with the carrying requirements of the LCM and the TLCM, so that the carrying cost and the waste of resources can be effectively reduced.

### BRIEF DESCRIPTION OF THE DRAWINGS

FIG. 1 is a schematic structural diagram showing a tray according to an embodiment of the present disclosure;

FIG. 2 is a top plan view schematically showing the tray of FIG. 1;

FIG. 3 is a schematic cross-sectional view taken along a line A-A′ of FIG. 2;

FIG. 4 is a schematic cross-sectional view taken along a line B-B′ of FIG. 2;

FIG. 5 is a schematic cross-sectional view in a width direction of the tray according to the embodiment of the present disclosure when loaded with an LCM;

FIG. 6 is a schematic cross-sectional view in the width direction of the tray according to the embodiment of the present disclosure when loaded with a TLCM;

FIG. 7 is a schematic cross-sectional view of a loading device (such as a carrier) for a display product according to an embodiment of the present disclosure; and

FIG. 8 is another schematic cross-sectional view of the loading device for the display product according to the embodiment of the present disclosure.

### DETAILED DESCRIPTION OF THE EMBODIMENTS

In order to better understand technical solutions of the present disclosure by those skilled in the art, a tray and a loading device for display products according to the embodiments of the present disclosure will be described in detail hereinafter with reference to the accompanying drawings.

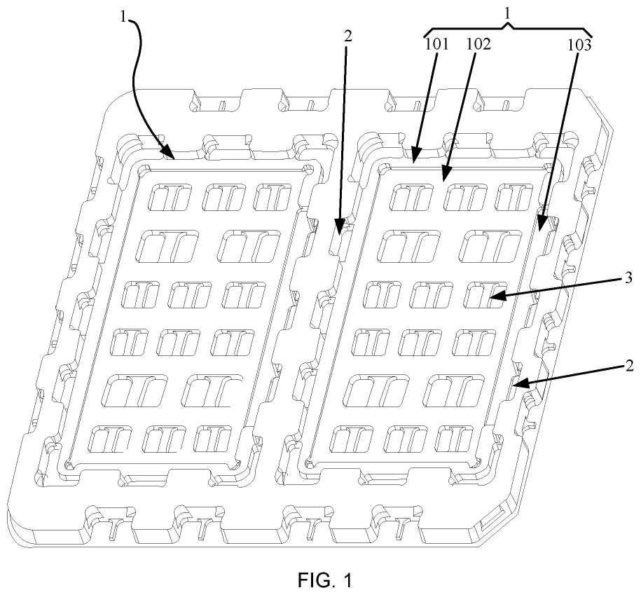

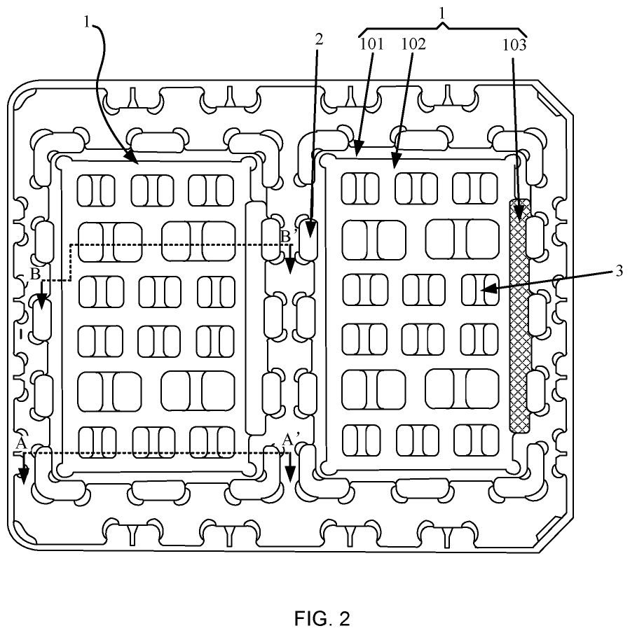

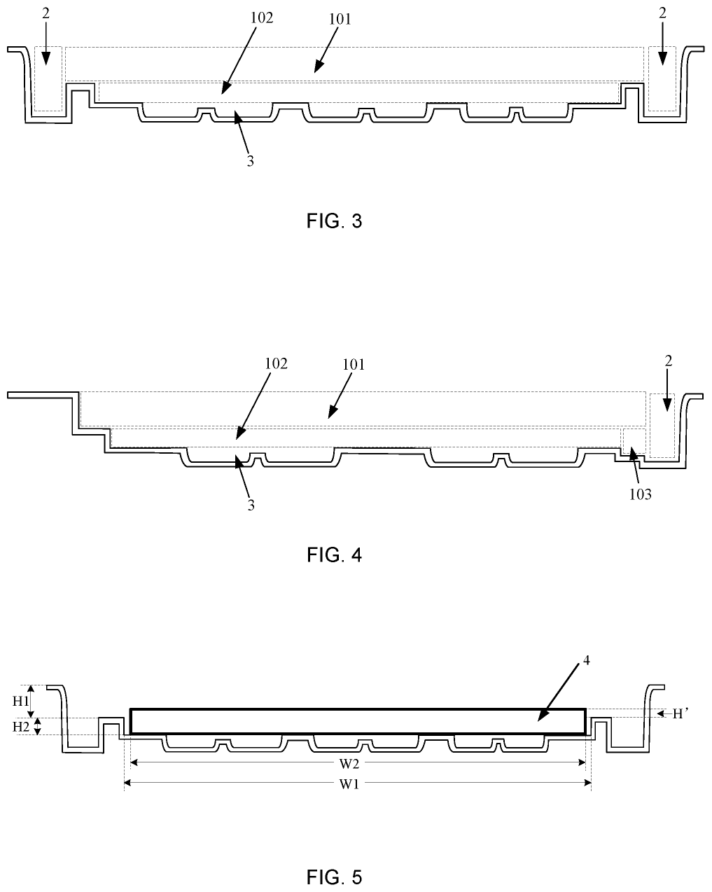

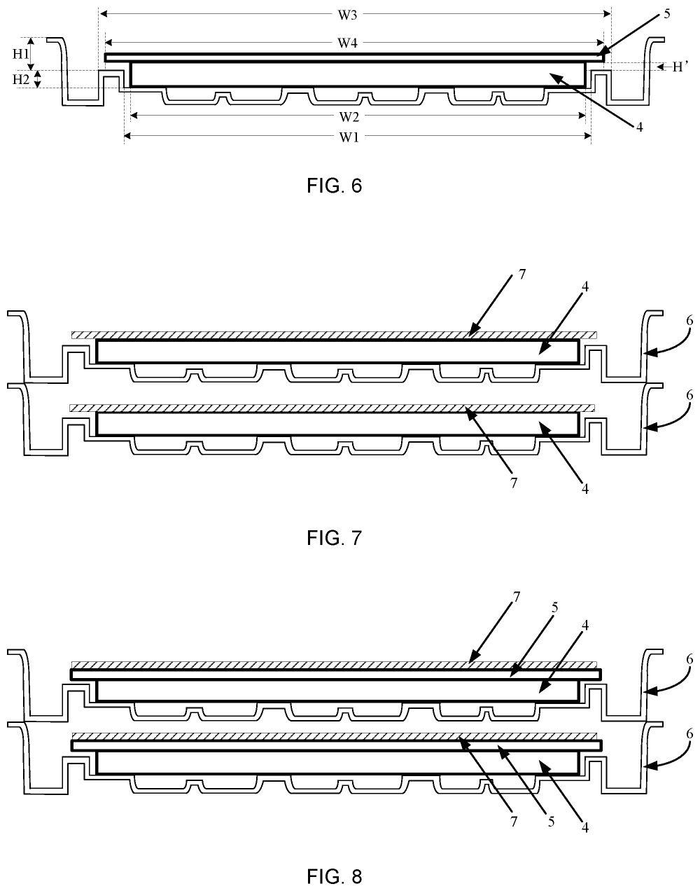

FIG. 1 is a schematic structural diagram showing a tray according to an embodiment of the present disclosure; FIG. 2 is a top plan view schematically showing the tray of FIG. 1; FIG. 3 is a schematic cross-sectional view taken along a line A-A′ of FIG. 2; FIG. 4 is a schematic cross-sectional view taken along a line B-B′ of FIG. 2; FIG. 5 is a schematic cross-sectional view in a width direction of the tray according to the embodiment of the present disclosure when loaded with an LCM; and FIG. 6 is a schematic cross-sectional view in the width direction of the tray according to the embodiment of the present disclosure when loaded with a TLCM. As shown in FIGS. 1 to 6, the tray includes at least one loading chamber 1, the loading chamber 1 comprising: a first restriction recess 101 and a second restriction recess 102 located within an edge of a bottom face of the first restriction recess 101, wherein the first restriction recess 101 is configured to load a touch cover 5 and limit the touch cover 5, and the second restriction recess 102 is configured to load an LCM 4 and limit the LCM 4. The LCM 4 typically includes: a backlight module and a liquid crystal display panel. The backlight module generally includes some structures such as a backlight, a light guide plate, a plastic frame, and an optical film. The touch cover 5 generally includes a touch panel and a glass cover. Typically, the LCM 4 has a thickness of 2.5 mm to 3.2 mm, and the touch cover 5 has a thickness of 0.5 mm to 0.7 mm.

In an embodiment of the present disclosure, when the LCM 4 is being carried, the LCM 4 simply needs to be placed in the second restriction recess 102; when the TLCM is being carried, the LCM 4 is simply placed in the second restriction recess 102 and the touch cover 5 is placed in the first restriction recess 101. As can be seen from the above, the tray according to the embodiment of the disclosure can satisfy with carrying requirements both of the LCM 4 and the TLCM, so that the carrying cost and the waste of resources can be effectively reduced.

As a specific scenario, after LCM 4 preparation is completed by the LCM manufacturing factory, the LCM 4 can be placed in the second restriction recess 102 of the tray for conveyance of the LCM 4. After the LCM 4 arrives at the TLCM manufacturing factory, the LCM is removed and the touch cover 5 is attached to a surface of the LCM 4 to obtain the TLCM. Finally, the TLCM is loaded into the same tray for conveyance of the TLCM.

Referring to FIGS. 1, 2 and 4, in some embodiments, the loading chamber 1 further includes a third restriction recess 103, arranged on the same side of the first restriction recess 101 and the second restriction recess 102 and communicated with the first restriction recess 101 and the second restriction recess 102. The third restriction recess 103 is configured to load and limit a Printed Circuit Board (PCB) connected to the LCM 4.

In some embodiments, the first restriction recess 101 has a rectangular or approximately rectangular cross-sectional shape, parallel to its bottom surface, and the touch cover 5 to be loaded in the first restriction recess 101 has a rectangular or approximately rectangular shape; the second restriction recess 102 has a rectangular or approximately rectangular cross-sectional shape, parallel to its bottom surface, and the TLCM to be loaded in the first restriction recess 101 has a rectangular or approximately rectangular shape.

Further, as shown in FIGS. 1 and 2, at least one corner of the first restriction recess 101 is formed as a convex rounded corner; and/or at least one corner of the second restriction recess 102 is formed as a convex rounded corner. In the case shown in FIGS. 1 and 2, four corners of the first restriction recess 101 are each configured to be convex rounded corners, and four corners of the second restriction recess 102 are each formed as convex rounded corners. In the embodiment of the present disclosure, if the process and the space are allowed, the rounded corners are designed as large as possible to increase smooth transition space, so that the corners of the LCM 4/touch cover 5 can be effectively prevented from contacting the second restriction recess 102/first restriction recess 101, and the risk of splintering of the LCM 4/touch cover 5 can be effectively reduced. In some embodiments, the rounded corner has a radius of more than or equal to 4 mm

Continuing to refer to FIGS. 5 and 6, in some embodiments, a difference between a length of the first restriction recess 101 and a length of the touch cover 5 to be loaded in the first restriction recess 101 is ranged from 0.5 mm to 0.7 mm; a difference W3-W4 between a width W3 of the first restriction recess 101 and a width W4 of the touch cover 5 to be loaded in the first restriction recess 101 is ranged from 0.5 mm to 0.7 mm In other words, the first restriction recess 101 has a size slightly larger than the touch cover 5 to be loaded therein so as to form a gap between the first restriction recess 101 and the touch cover when the touch cover 5 is loaded.

In some embodiments, a difference between a length of the second restriction recess 102 and a length of the LCM 4 to be loaded in the second restriction recess 102 is ranged from 0.5 mm to 0.7 mm; a difference W1-W2 between a width W1 of the second restriction recess 102 and a width W2 of the LCM 4 to be loaded in the second restriction recess 102 is ranged from 0.5 mm to 0.7 mm In other words, the second restriction recess 102 has a size slightly larger than the LCM 4 to be loaded therein so as to form a gap between the second restriction recess 102 and the touch cover when the LCM 4 is loaded.

Continuing to refer to FIGS. 5 and 6, in some embodiments, a difference H′ between a thickness of the TLCM to be loaded in the second restriction recess 102 and a depth H2 of the second restriction recess 102 is ranged from 0.1 mm to 0.3 mm. The touch cover 5 has a size larger than the TLCM, so as to avoid light leakage in a peripheral area of the touch cover 5. An ink printed layer is generally disposed on the peripheral area of a lower surface of the touch cover 5. When the tray according to the embodiment of the present disclosure is loaded with the TLCM, a gap of 0.1 mm to 0.3 mm is formed between the lower surface of the touch cover 5 and the bottom surface of the second restriction recess 102, thereby preventing ink damage or drop due to friction between the tray and the touch cover 5 during transportation.

In the embodiment of the present disclosure, the depth H2 of the second restriction recess 102 is designed according to a thickness of the TLCM to be loaded. Typically, the TLCM has a thickness in the range of 2.5mm to 3.2 mm Taking an example that a distance of 0.2 mm is formed between a lower surface of the touch cover 5 and a plane where the bottom surface of the second restriction recess 102 is located, that is, the depth of the first restriction recess 101 is 0.2 mm greater than the thickness of the TLCM to be loaded, the depth H2 of the second restriction recess 102 is ranged from 2.3 mm to 3.0 mm.

In the embodiment of the present disclosure, a depth H1 of the first restriction recess 101 is designed according to a thickness of the touch cover 5 to be loaded, a pre-designed reserved distance between a plane where an upper surface of the LCM 4 is located and a plane where an upper surface of the tray is located, and a distance between a plane where an upper surface of the LCM 4 is located and a plane where a bottom surface of the first restriction recess 101 is located. Typically, the depth of the first restriction recess 101 is greater than the thickness of the touch cover 5 to be loaded. Taking an example that the pre-designed reserved distance between the plane where the upper surface of the LCM 4 is located and the plane where the upper surface of the tray is located is 1.2 mm to 1.5 mm and the distance of 0.2 mm is formed between the lower surface of the touch cover 5 and the plane where the bottom surface of the second restriction recess 102 is located, the first restriction recess 101 has a depth H1 of 1.4 mm to 1.7 mm.

In some embodiments, the bottom surface of the second restriction recess 102 is provided with a wavy reinforcing rib 3. In an embodiment of the present disclosure, the design of the wavy reinforcing rib 3 can enhance a hardness of the bottom surface of the second restriction recess 102, and thus can effectively reduce or even completely avoid deformation of the bottom surface of the second restriction recess 102.

In some embodiments, a plurality of grooves 2 for picking up articles are arranged around the loading chamber 1, the plurality of grooves 2 for picking up articles are arranged at intervals along an edge of the loading chamber 1 and are communicated with the loading chamber 1, and a distance from a bottom surface of each groove 2 for picking up articles to the top surface of the tray is greater than the distance from the plane where the bottom surface of the second recess is located to the plane where the top surface of the tray is located. In the embodiment of the disclosure, the design of the groove 2 for picking up articles can assist a manufacturer in taking out the LCM 4 or the TLCM.

Continuing to refer to FIGS. 1 and 2, there can be provided two loading chambers 1 which are arranged along a width direction of the loading chambers 1.

In some embodiments, the material of the tray includes plastic; the tray made of plastic material has a light weight, so as to facilitate transportation of the tray device with loaded LCMs 4 or TLCMs. In some embodiments, the material of the tray includes a PET material (polyethylene terephthalate).

Further, the tray is integrally formed by injection molding. The injection molding method has simple process and short preparation time, and is beneficial to improvement of the molding efficiency of the tray.

Based on the same inventive concept, there is further provided a loading device for a display product in an embodiment of the present disclosure. The loading device includes: at least one tray and resilient gasket; the tray adopts the tray according to any one of the embodiments as set forth above, and for specific statements of the tray, reference can be made to corresponding contents in the embodiments above, the details of which will not be repeatedly described; the resilient gasket is placed in the first restriction recess of the tray, and the resilient gasket in the embodiment of the present disclosure will be described in detail later with reference to a specific example.

FIG. 7 is a schematic cross-sectional view illustrating a loading device (such as a carrier) for the display product when carrying the LCM 4 according to an embodiment of the present disclosure, and FIG. 8 is another schematic cross-sectional view illustrating the loading device for the display product when carrying the TLCM according to an embodiment of the present disclosure. As shown in FIGS. 7 and 8, in the case as exemplarily shown in FIG. 7, two trays 6 are stacked one above the other and the LCM 4 is placed in each tray 6, and in the case as exemplarily shown in FIG. 8, two trays 6 are stacked one above the other and the TLCM is placed in each tray 6. To avoid the collision between the LCM 4 in the lower tray 6 and the bottom surface of the upper tray 6, a resilient gasket 7 is typically disposed above the LCM 4 or TLCM, and the resilient gasket 7 is disposed in the first restriction recess 101 of the tray 6. The material of the resilient gasket 7 can be rubber, sponge, and foam, etc., which is not limited in the disclosure.

In some embodiments, the resilient gasket 7 has a thickness of 0.6 mm to 0.8 mm; optionally, the resilient gasket 7 has a thickness of 0.7 mm.

It should be noted that, in some embodiments of the present disclosure, the number of trays 6 can be one, three or more and are not described here by way of example.

It will be understood that the above embodiments are merely exemplary embodiments employed to illustrate the principles of the present disclosure, and the present disclosure is not limited thereto. It will be apparent to those skilled in the art that various modifications and improvements can be made therein without departing from the spirit and scope of the disclosure, and these modifications and improvements are intended to be considered within the scope of the disclosure.

1. A tray, comprising at least one loading chamber, wherein
the loading chamber includes: a first restriction recess and a second restriction recess located within an edge of a bottom face of the first restriction recess, wherein the first restriction recess is configured to load a touch cover and limit the touch cover, and the second restriction recess is configured to load a liquid crystal module and limit the liquid crystal module.

2. The tray according to claim 1, wherein the loading chamber further comprises a third restriction recess, arranged on the same side of the first restriction recess and the second restriction recess and communicated with the first restriction recess and the second restriction recess, and wherein the third restriction recess is configured to load and limit a printed circuit board connected to the liquid crystal module.

3. The tray according to claim 1, wherein the first restriction recess has a rectangular cross-sectional shape parallel to a bottom surface of the first restriction recess, and the touch cover to be loaded in the first restriction recess has a rectangular shape; and
the second restriction recess has a rectangular cross-sectional shape parallel to a bottom surface of the second restriction recess, and the liquid crystal module to be loaded in the second restriction recess has a rectangular shape.

4. The tray according to claim 3, wherein at least one corner of the first restriction recess is formed as a convex rounded corner; and/or
at least one corner of the second restriction recess is formed as a convex rounded corner.

5. The tray according to claim 4, wherein the rounded corner has a radius more than or equal to 4 mm.

6. The tray according to claim 3, wherein a difference between a length of the first restriction recess and a length of the touch cover to be loaded in the first restriction recess is ranged from 0.5 mm to 0.7 mm; and
a difference between a width of the first restriction recess and a width of the touch cover to be loaded in the first restriction recess is ranged from 0.5 mm to 0.7 mm.

7. The tray according to claim 3, wherein a difference between a length of the second restriction recess and a length of the liquid crystal module to be loaded in the second restriction recess is ranged from 0.5 mm to 0.7 mm; and
a difference between a width of the second restriction recess and a width of the liquid crystal module to be loaded in the second restriction recess is ranged from 0.5 mm to 0.7 mm

8. The tray according to claim 1, wherein a difference between a thickness of the liquid crystal module to be loaded in the second restriction recess and a depth of the second restriction recess is ranged from 0.1 mm to 0.3 mm

9. The tray according to claim 1, wherein the first restriction recess has a depth of 1.4 mm to 1.7 mm

10. The tray according to claim 1, wherein the second restriction recess has a depth of 2.3 mm to 3.0 mm

11. The tray according to claim 1, wherein the bottom surface of the second restriction recess is provided with a wavy reinforcing rib.

12. The tray according to claim 1, wherein a plurality of grooves for picking-up are arranged around the loading chamber,
the grooves for picking-up are arranged at intervals along an edge of the loading chamber and are communicated with the loading chamber, and
a distance from a bottom surface of each groove for picking-up to the top surface of the tray is greater than the distance from the bottom surface of the second recess to the top surface of the tray.

13. The tray according to claim 1, wherein two loading chambers are provided and are arranged along a width direction of the loading chambers.

14. The tray according to claim 1, wherein a material of the tray includes plastic; and
the tray is integrally formed by injection molding.

15. A loading device of display product comprising:
at least one tray according to claim 1; and
a resilient gasket, arranged in the first restriction recess of the tray.

16. The loading device of display product according to claim 15, wherein the loading chamber further comprises a third restriction recess, arranged on the same side of the first restriction recess and the second restriction recess and communicated with the first restriction recess and the second restriction recess, and wherein
the third restriction recess is configured to load and limit a printed circuit board connected to the liquid crystal module.

17. The loading device of a display product according to claim 15, wherein the first restriction recess has a rectangular cross-sectional shape parallel to a bottom surface of the first restriction recess, and the touch cover to be loaded in the first restriction recess has a rectangular shape; and
the second restriction recess has a rectangular cross-sectional shape parallel to a bottom surface of the second restriction recess, and the liquid crystal module to be loaded in the first restriction recess has a rectangular shape.

18. The loading device of a display product according to claim 17, wherein at least one corner of the first restriction recess is formed as a convex rounded corner;
and/or at least one corner of the second restriction recess is formed as a convex rounded corner; and
the rounded corner has a radius more than or equal to 4 mm

19. The loading device of a display product according to claim 17, wherein a difference between a length of the first restriction recess and a length of the touch cover to be loaded in the first restriction recess is ranged from 0.5 mm to 0.7 mm;
a difference between a width of the first restriction recess and a width of the touch cover to be loaded in the first restriction recess is ranged from 0.5 mm to 0.7 mm;
a difference between a length of the second restriction recess and a length of the liquid crystal module to be loaded in the second restriction recess is ranged from 0.5 mm to 0.7 mm; and
a difference between a width of the second restriction recess and a width of the liquid crystal module to be loaded in the second restriction recess is ranged from 0.5 mm to 0.7 mm

20. The loading device of a display product according to claim 15, wherein a plurality of grooves for picking-up are arranged around the loading chamber,
the grooves for picking-up are arranged at intervals along an edge of the loading chamber and are communicated with the loading chamber, and
a distance from a bottom surface of each groove for picking-up to the top surface of the tray is greater than the distance from the bottom surface of the second recess to the top surface of the tray.
